(19) United States
(12) Patent Application Publication
(10) Pub. No.: US 2023/0196342 A1
(43) Pub. Date: Jun. 22, 2023

(54) SYSTEMS AND METHODS FOR MULTIPLE SMART CONTRACTS FOR MULTIPLE LEDGER NON-FUNGIBLE TOKENS AND METHODS FOR MANAGING THE SAME

(71) Applicant: Dynamics Inc., Cheswick, PA (US)

(72) Inventors: Jeffery D. Mullen, Glenshaw, PA (US); Jonathan L. Beaver, Cranberry, PA (US)

(21) Appl. No.: 18/084,526

(22) Filed: Dec. 19, 2022

Related U.S. Application Data
(60) Provisional application No. 63/291,322, filed on Dec. 17, 2021.

(51) Int. Cl. G06Q 20/36; G06Q 20/38; G06Q 20/40

(52) U.S. Cl. CPC G06Q 20/3672; G06Q 20/389; G06Q 20/401

(57) ABSTRACT

One or more smart contracts on a ledger (e.g., a public blockchain) may work in tandem, for example, to associate non-fungible tokens on multiple (e.g., two or more) different ledgers to be represented simultaneously and/or sequentially on the multiple ledgers utilizing an intermediary tokenization representation on the one or more smart contracts. A smart contract, of feature of a smart contract, may be utilized to verify the association on each individual ledger using features of those individual ledgers.

### CROSS-REFERENCE TO RELATED APPLICATION

This application claims the benefit of U.S. Provisional Patent Application No. 63/291,322, titled “SYSTEMS AND METHODS FOR MULTIPLE SMART CONTRACTS FOR MULTIPLE LEDGER NON-FUNGIBLE TOKENS AND METHODS FOR MANAGING THE SAME,” filed Dec. 17, 2021, which is hereby incorporated by reference herein in its entirety.

### BACKGROUND OF THE INVENTION

This invention relates to non-fungible tokens.

### SUMMARY OF THE INVENTION

A multiple ledger non-fungible token (NFT) is provided that includes ledger data that can be read and written by a public processing system such as, for example a public blockchain system and ledger data that can be read and written by a private processing system such as, for example, a private blockchain system. Any number of public ledgers and/or private ledgers may have data structures included in the multiple ledger NFT. For example, a single public blockchain may be utilized as the public blockchain for a multiple-ledger NFT token. One or more private blockchains may be utilized as private blockchains for a multiple-layer NFT. Persons skilled in the art will appreciate that a multiple-ledger NFT may be scalable to any private blockchain such that blockchains that are created after the multiple-ledger NFT is created can be utilized with the multiple-ledger NFT.

### BRIEF DESCRIPTION OF THE DRAWINGS

The principles and advantages of the present invention can be more clearly understood from the following detailed description considered in conjunction with the following drawings, in which the same reference numerals denote the same structural elements throughout, and in which:

FIG. 1 are illustrations of platforms constructed in accordance with the principles of the present invention;

FIG. 2 are illustrations of flow charts constructed in accordance with the principles of the present invention;

FIG. 3 are illustrations of flow charts constructed in accordance with the principles of the present invention; and

FIG. 4 are illustrations of flow charts constructed in accordance with the principles of the present invention.

### DETAILED DESCRIPTION OF THE INVENTION

An NFT platform is provided that is a new platform designed to allow the trading, buying and selling of Non-Fungible Tokens (NFTs). This platform is part of an overall solution provided to provide collectors of various NFTs a site where they can go both to generate and manage their collection, while also interacting with a similar community and be able to perform various activities using the objects they have collected.

The key feature of the platform is the usage of block chain technology and allowing interactions between the platform website, the backend private block chain technology, and public block chains, starting with the largest public block chain for NFTs, Ethereum.

This white paper will provide a brief background into NFTs on public block chains, how interaction will occur between the platform and those block chains, and some of the features the smart contracts and block chain interaction provide.

The goal of this document is to provide both an overview of how the platform works with NFTs and provide some important technical and cost details to allow a complete understanding of the NFT portion of the platform.

There are three main platforms that make up the overall platform solution. There is the website/internet-based interface where users primarily interact with their NFT collections, the internal database/block-chain platform operates for maintaining NFTs, and the external public block chain called Ethereum.

The NFT platform website utilizes a combination of .net Core, node.js, html, jquery, css and other web related features to provide a fully interactive and dynamic site. The site is viewable on any screen, from a phone to large monitor. This white paper will not dive too deeply into the details of this site, other than to mention it is the primary way customers of the platform will obtain, import and export NFTs, along with being able to buy, sell and trade them with other customers.

A standard relational database may be utilized, for example, for storing the details and information about the NFTs that are obtainable through the platform. This relational database keeps track of all transactions that occur within the system, including when the NFT was obtained (and by which user), when and to whom the NFT was traded/sold/bought/etc., and includes information about the NFT if it has been moved into or received from external blockchains, such as the external Ethereum blockchain.

To handle the communication with the first public block chain being utilized, Ethereum, two smart contracts within Ethereum are used: An NFT Smart Contract, which creates Ethereum NFTs from NFTs, and the Verification Smart Contract, which verifies NFTs on Ethereum and stores collectable set NFT information on Ethereum.

When an NFT collectible is initially created, the collectible is (1) created as an NFT in the internal relational database and (2) mapped to a collectible set NFT placed on the Ethereum through the Verification Smart Contract. In this way, all NFTs can be viewed/verified via Ethereum Smart Contracts using the information on the associated collectable set NFT. This allows two types of verifications to be performed. The first verification is before an NFT is minted on Ethereum to confirm the NFT is mapped in a collectable set NFT in the Verification Smart Contract. The second verification is after the NFT is minted on Ethereum to map the Ethereum NFT back to the internal NFT.

When an NFT is exported, the NFT Smart Contract creates an Ethereum NFT for that collectible and maps the newly created Ethereum NFT to the NFT and the initial product NFT. After export to Ethereum, the internal system also receives history information from Ethereum itself when something happens with an exported NFT, so a complete history can be maintained. This is done through the use of events emitted by the NFT Smart Contract on the Ethereum network. By utilizing events, exported NFTs will have their Ethereum updates tracked on the platform itself.

An internal, private block chain-based storage system Is also provided in addition to the use of an internal, relational database and the external, public Ethereum blockchain. This internal, private block chain version is currently based on the Ethereum Geth programming logic, but would provide another layer of accountability and trackability to the history and interactions with a given NFT. When launched, this internal, private blockchain would be exposed to the public—making it an internal, but public blockchain. In doing so, anyone could join the Block Chain and be able to query the history and view all transactions associated with any NFT that has been obtained. For security and stability, only the systems would initially be able to perform the mining and account creation at the current time, since the block chain would not be providing external parties any currency to use on it, those transactions would all need to occur through the platform Website.

The final platform is the Ethereum public block chain, which is where the primary smart contracts created are being deployed. This is an entirely publicly controlled block chain operating using Ether. NFTs will be able to be exported from the Internal System to Ethereum and from Ethereum to the Internal System. When the NFT is on Ethereum, it is completely controlled outside of Dynamics. While will be able to see any transactions that happen, the owner controls it using their Ethereum user id and can sell it, transfer it, etc.

One of the key features of the NFT program is the development and usage of several proprietary Ethereum Smart Contracts for the public Ethereum block chain. A smart contract is essentially a program that is deployed on the Ethereum Block Chain against which anyone can call functions, if they know the address of the contract within Ethereum and the basic signature of the function (and have appropriate permissions controlled by the Smart Contract code). Because of this, it is important to have a lot of security and control built into each function within your smart contract, to ensure nothing malicious or unexpected happens.

Interacting with Smart Contracts can be performed by utilizing API calls against Ethereum nodes. These API calls can be made directly through code (C#, Java) or some companies have designed programs/interfaces that communicate through websites and obscure the functionality from end users. For the platform project, the majority of the interactions occur through the platform website/backend using a node that has been created that is part of the Ethereum public block chain. Initially, this will be a full node used to analyze the chain and submit smart contracts/calls against the smart contract functions. In the future, this may be updated to be a mining node for Ethereum.

In general, a Smart Contract can perform actions on a blockchain, such as actions on an Ethereum Block Chain. For example, actions may include (i) Store Data—This can be updating a value, adding a value to an array, setting a variable, etc; (ii) Retrieve Data—This can be looking up a value stored in a variable, array, etc; (iii) Transfer Ether—It is possible if a function in Ethereum is marked payable that a user can provide Ether to the function call and that function call can distribute the ether to the smart contract or other users.

In the case of the Dynamics. NFT Smart Contract, there are a series of pre-determined functions/functionality that a Smart Contract provides to have an Ethereum NFT. One important piece of information to know about Ethereum “NFTs” is that a Ethereum NFT is are just a number of a token inside a smart contract and any associated stored information. The data of an NFT may or may not be in Ethereum. For example, an NFT may just be an id and a link to information on the NFT stored “off chain” or outside of Ethereum. Because of this, the Ethereum version of NFTs may need a particular interface or off chain system for extended functionality. The following functions may be provided with blockchain calls (e.g., Ethereum NFT calls) (platform includes a metadata NFT). Blockchain calls may include (i) balanceOf—this is used to determine the number of NFTs an owner has inside that smart contract. You pass in an owner address; (ii) ownerOf—this is used to get the address of the owner of a specific NFT. You pass in an integer, because as mentioned an NFT in Ethereum is just a number in an array; (iii) safeTransferFrom/transferFrom—these are used to change the owner of an NFT; (iv) approve—This is used for an owner to approve another owner of being allowed to control their NFT; (v) setApprovalForAll—this allows an owner to set a specific owner to be approved to control all their NFTs; (vi) getApproved—Get the owner address approved to control a specific NFT; (vii) isApprovedForAll—whether a specific owner is approved to control all NFTs for another owner; (viii) name—this gets the name property of the NFT. The name is at the smart contract level; (ix) symbol—this gets the symbol property of the NFT. The symbol is at the smart contract level; (x) tokenURI—This gets the distinct Uniform Resource Identifier (URI). The URI is a key feature of the Ethereum NFT, as it contains any specific on-chain data/references for that NFT. Typically, this URI is a link to an image (stored off chain) or is a little more involved “json” string, which contains a collection of key/value pairs of data. This can be a bit more complicated than just a few key value pairs, as will be shown with the Dynamics' version of this function. Persons skilled in the art will appreciate that these functions nay exist, for example, to the extent needed to provide the associated functionality, in the NFT Smart Contract as well.

Another important feature of the Smart Contract is the cost associated with performing anything associated with the smart contract. Anytime that data is manipulated on the public Ethereum chain, whether it is added, removed, updated, or even ether is transferred, there is an associated cost. It is also important to know that if a function was intended to change data, but fails because a check fails or access is denied, there is still a charge. In general, costs for smart contracts are based primarily on the following (1) How much data is being changed (on a byte level)—does not matter if stored or updated; (2) How many operations are occurring inside the function (such as concatenating strings, or searching for a value, or looping or any other computational operation). The costs are calculated in terms of total gas used multiplied by the cost of one unit of gas. One unit of gas is essentially equivalent to running one compiler level registry check, and every byte of data requires another unit of gas. The typical cost of one unit of gas at the time this document was written was around 120 GWei (0.00000012 ether). So, if ether costs $4,000 each, it typically costs $0.00048 to perform just one internal option or pass 1 byte of data to a smart contract. Given the minimum amount of gas that can be used in any contract operation is 21000, that means to do the most basic operation on Ethereum, it takes 0.00252 Ether, which at $4,000 for Ether, is $10 to perform the cheapest operation on Ethereum where data changes.

There are also functions on smart contracts which are designated as pure or view. For these functions, unless they are called by another function in the smart contract that is changing data, there is no cost to use these functions. So, much of the functionality should be inside these functions.

Below is a quick list of some standard Smart Contract (and NFT) functions in Ethereum and some potential costs in both gas and USD, if Ether costs $4,000 each, for example, then (1) Transfer Ether—21000 Gas—$10; (2) Change the Owner of an NFT—˜35000 Gas—$17; (3) Get the Token URI—0 Gas—$0; (4) Deploy Standard NFT Smart Contract—2503568 Gas—$1,200.

The first of a two or more smart contract provision may be provided as primary smart contracts provided is being referred to as the Verification Smart Contract. The primary purpose of this contract is to allow for a line in the sand date and details on NFTs that are generated by the platform to exist in Ethereum. This contract will be able to be referenced at any time to get the mapping between NFTs on platform and NFTs on Ethereum. It provides a quick (and free) way for potential buyers or users to check on the status of NFTs maintained within the platform while being able to reference back to an origination date on Ethereum that is potentially much earlier.

Ability to look up NFTs from various products in the environment and find the related platform information. The user would provide an Ethereum NFT ID (a simple integer) and possibly an platform product id (GUID or Integer or String, or other). The system would provide back a json blob containing two web addresses. Link to show an image on the planetary file system for that product that shows the mapping of the Ethereum NFT ID to platform ID for a product. Link to the platform website which will point to the exact NFT on platform. This may show the actual card image/details, or it may show “unacquired” or “unopened” image for the NFT. Each product includes a product id, a starting index and ending index. The actual block chain history in Ethereum will provide the origination date for the product Functions may include (i) VerifyplatformNFT—This will be available to any user or system to call and receive the information on a specific Ethereum NFT id; (2) AddplatformProduct—Used to add a new platform product, providing the unique product id, name, start index, end index. The index will need to be unique across all products; (3) SetLinkData—Used to update the base links if needed (not expected to be used but provided in case it is desired to change internal addresses or ownership of platform changes.)

A contract designed to be inexpensive to both create and maintain may be provided. The lookup functions may be all free operations, because they are just returning data and not modifying anything. Below is the estimated gas cost/real world cost for this smart contract:

| | | Est Cost |
|---|---|---|
| Functionality | Gas Cost | @4,000/Ether |
| Deploy Smart | 1463402 | $702 |
| Contract | | |
| Add platform | 144000 | $69 |
| Collectable Set | | |
| Set Link Data For | 118000 | $57 |
| Entire Collectable | | |
| Set | | |
| Verify platform | 0 | 0 |
| List | | |

The second of the two primary contracts is the NFT Smart Contract. This white paper discusses the single contract version that holds all NFTs within Ethereum. There are also ongoing discussions about having a separate option where a smart contract is created for an individual NFT on Ethereum. That will be discussed in a separate white paper as it carries an extremely high cost that makes it currently unusable, but in general it would contain the same basic functionality as the Smart Contract discussed below other than only allow a single NFT to exist inside of it.

The key to understanding and using the NFT Smart Contract is to understand what exactly an NFT is on the Ethereum Block Chain. As mentioned previously, on the surface an Ethereum NFT appears to be an image, or movie, or something else, when in actuality within Ethereum it is a link between a single big integer id and a user id. There is the ability to store some data (mentioned previously as a URI) on the chain that the id can retrieve, but that typically is very costly so the majority of Ethereum NFTs will just return a small URI which links to or references more data, including the actual “image” the Ethereum NFT represents. Additionally, the majority of Ethereum NFTs require a third-party site to perform buying and selling, as the actual paying/buying of NFTs is typically not built into Ethereum NFT smart contracts. Instead, the smart contract allows for transferring ownership but then the money exchange (or Ether exchange) is done through a separate call or piece of functionality.

The NFT Smart Contract takes this basic way Ethereum NFTs operate and adds additional layers of both content and functionality to allow NFTs to be evolvable and autonomous on the Ethereum block chain. This additional functionality not only gives NFT owners more control over their specific NFT but also increases the overall value of the NFT by allowing more flexibility in how the NFT is used, maintained and sold or exchanged in the future within Ethereum or other block chains.

Features may include (i) Ability for each individual owner to provide content for an NFT if they are the owner; (ii) Ability for each previous owner to update their specific owner provided data even if they no longer own the NFT (iii) Ability for NFT creator/minter to add/update NFT data at a global or individual token level; (iv) Ability to “Mint” an NFT, which is the initial assignment of a specific NFT token id to a user; (v) Ability to “Sell” an NFT and require payment be included as part of the sale if wanted. Additional Specific Functions may be provided including (i) updateMinter—In order to enable parallel exporting of NFTs, multiple ids need to be created and enabled to mint NFTs. This allows adding or removing a minter; (ii) exportNFT—Used to initially assign a token to an owner on export. This is only used the first time an NFT is exported to Ethereum; (iiI) updateURIData—This can be called by minters or creators to set/update/append the shared global data or individual minter level token data. This is key/value based; (iv) updateOwnerData—This can be called by the current or previous owners and allows them to set/update/append ledger data. This is key/value based per owner ledger; (v) enableAcquireNFT—This is a special function that allows the current owner to specify another user to become the owner of their NFT on Ethereum while specifying a price for the transaction in Wei; (vi) AcquireNFT—This is a special function that a buyer can call if they were enabled via the enableAcquireNFT to take ownership of an NFT on Ethereum given they provide enough value to pay the previous owner; (vii) NOTE: There is a setting that will take a % of the payment and pay it to platform to maintain data on these activities. This may or may not be enabled (vii) Any functionality that may be provided in a base Ethereum NFT interface or other blockchain or NFT interface. An expanded version of tokenURI may be provided which will return all the various owner data that is attached to the NFT on Ethereum.

A contract may have a lot of functionality, and may be provided with all the flexibility previously mentioned. When utilized as a standard Ethereum NFT contract, the costs will be comparable to any other NFT Smart Contract on Ethereum. For the functions that set or update data, it is important to note the cost will linearly increase based on the number of bytes that are being saved. The Gas Cost shown is based on a 10-byte key, 20-byte payload. But the larger the key or payload, the more it will cost in gas.

| | | Est Cost |
|---|---|---|
| Functionality | Gas Cost | @4,000/Ether |
| Deploy Smart | 3959529 | $1,900 |
| Contract | | |
| Add Minter | 46277 | $22 |
| Export NFT | 138000 | $66 |
| | 189000 | $90 |
| Update URI Data | 76000 | $36 |
| Update Owner Data | 95000 | $45 |
| Enable Acquire NFT | 49000 | $23 |
| Acquire NFT | 99000 | $47 |
| (External System | | |
| Pays) | | |
| balanceOf | 0 | 0 |
| ownerOf | 0 | 0 |
| safeTransferFrom | 110000 | $52 |
| transferFrom | 110000 | $52 |
| Approve | 48800 | $23 |
| setApprovalForAll | 46000 | $22 |
| getApproved | 0 | 0 |
| isApprovedForAll | 0 | 0 |
| Name | 0 | 0 |
| Symbol | 0 | 0 |
| TokenURI | 0 | 0 |

The interaction between Ethereum and platform occurs in three primary ways: Importing an NFT, Viewing an NFT, and Exporting an NFT. All three of these interactions involve performing activities on Ethereum, either behind the scenes by the platform or by the user account of the NFT owner.

A key feature of platform is the ability for owners of NFTs (such as Ethereum NFTs) to import those NFTs into the platform. As previously discussed, an NFT on Ethereum is the ownership of a token in a specific smart contract. When an Ethereum NFT is imported into the platform, the current owner of the Ethereum NFT will be provided a (platform) User Id to which to transfer ownership of the Ethereum NFT. The owner can then use that User Id to either transfer the token via the transferFrom/safeTransferFrom command or in later versions of platform, Approve the platform User Id and then the platform will perform the transferFrom. In both scenarios, the Ethereum NFT will only become available in the platform after it is confirmed that the ownership transfer has completed. This is performed by verifying the ownerOf returns the id of the platform id provided for that token and getApproved returns empty (to ensure there is not a way the NFT can be taken back). As part of this import process, additional setup information may be required to make the Ethereum NFT fully available in the platform. This may include providing some metadata or having certain additional verification activities take place. At a minimum, the platform will record information from the originating blockchain, including the smart contract the NFT is from and history information from the related blockchain to allow a full understanding of the NFT. The owner will also need to specify an platform account to load the NFT info, and proper validation will occur on that end as well.

One important item of note is the platform User ID that was mentioned will be provided to the current owner of the NFT. Currently, this user id will be unique per NFT that is imported. Essentially, the platform will create a user on Ethereum for each NFT that is being imported. This user id will be owned and controlled by platform; it is not technically assigned to any user but is used by platform to keep track of external NFTs. This will also be important when it comes to exporting the NFT back to Ethereum, as having a separate user id allows more concurrent activity to take place.

In order to make interaction with NFTs that either originated on a different system or have been exported but used to be managed on platform more reliable and relevant, platform will maintain historical information on the Ethereum portion of the NFTs, including the smart contract they are part of, any blocks where activity occurred on that NFT, and where possible (specifically if it is the NFT Smart Contract but also using the general NFT interface) what was the exact activity that occurred (function name, parameters, etc.). This information will be made available through interface features within platform and using a history management system designed against the public Ethereum node that platform utilizes.

The other key feature of platform is the ability to take an NFT (either imported into platform or originated by platform) and export that NFT to the Ethereum public block chain (initially, eventually this will include many other public block chains where possible). There are two basic ways an NFT is exported out of the platform, which are based in how the NFT appeared within the platform.

In this scenario, the NFT was created as part of the platform and therefore does not currently exist outside of an NFT Smart Contract. This means that the NFT will have all the data and functionality that is available for an NFT, even if it was exported and imported previously. The reason for this is when an NFT is exported out of platform, it is the same basic logic as was explained for NFTs in general. The NFT Smart Contract is accessed and a transferFrom is executed. The new owner will need to provide a user id on the public block chain the NFT is being exported to, and the ownership of that NFT inside the NFT Smart Contract will be set or updated to the user id provided. Unlike NFTs that did not originate on platform, any NFT will also have the option to export the NFT history from platform into the NFT (at an additional cost). This is not required but allows an owner to have the value of their NFT enhanced by having all activity from other block chains (such as the Private Block Chain) written to the public block chain so the information exists even without the platform itself existing. This is done through the use of the Update URI Data call which updates the URI Data for that specific NFT to include key value pairs for the platform history of the NFT.

Also, unlike an NFT that was originally imported into platform, the user id that performs the exporting may be one of many approved platform User Ids. In order to minimize delays in exportation, platform will have a myriad of user ids that are approved within the NFT Smart Contract to perform activities such as transferring ownership or adding URI data to the NFT. These ids will be available within the platform to verify they are valid platform accounts, in case an owner wants to verify the security and validity of the user that performed the activities.

In this scenario, the NFT was originally from Ethereum (or another approved block chain) and is being placed back on that block chain. Due to the unique nature of how the NFT was brought into platform, it will essentially be moved back to the originating block chain in the same manner. The new owner will be required to provide platform their user id within the external block chain. platform will then use the same transerFrom or similar operation that was used to move the NFT into platform and transfer ownership to the new owner. If the NFT on the external block chain implements the platform interface, and the user requested to have history data exported, then that additional functionality will be called an executed during export. Otherwise, just the ownership of the NFT will be set to the new owner's id. platform will keep history of this event within the internal object maintained for that NFT on platform in case the NFT is ever brought back into platform to allow a fully history of the NFT to be maintained.

One import piece of information to keep in mind is because the NFT was given a unique user id to transfer to within platform when it was imported, only that unique user id will be involved in exporting the NFT. This allows further assurance for individuals that export an NFT that this NFT is the one that was originally on the public block chain to begin with and makes it easier to track the public block chain portion of the history of the NFT.

A feature of the provided NFTs is their survivability, which is the ability for the NFT to exist in situations where any party associated with platform no longer exist or are shut down. In many online systems, the data is stored and maintained only with systems operated by the company that created the system. If that company were to go out of business or stop supporting the system, anything associated with the system is essentially lost. There are many examples of this, from online video games, online card collecting sites, twitter, facebook, etc. . . . All of these systems only exist as long as the company that created and hosted the system exists. Once they are gone, the data is most likely gone with them (or at least access to the data is gone with them).

With NFTs, especially those that are maintained on a public block chain like Ethereum, the data is not maintained in a single location, it is maintained in thousands of nodes around the world. Because of this, it does not matter if the platform were to disappear as any NFT placed onto a public block chain would persist. It is also important to note that once an NFT is moved into Ethereum and ownership transferred away from the platform, there is no way to control the NFT either. Any user anywhere in the world is able to call functions associated with a Smart Contract in Ethereum. Only the security logic in the Smart Contract would stop actions from happening, and almost all the security logic is based on the current NFT owner. This is why NFTs are essentially permanent and controlled by the owner, not the minter or creator, for all time, making them a very survivable asset. This white paper provided an overview of how the platform will interact with NFTs and Smart Contracts on Ethereum for the purpose of creation, importation, viewing and exporting NFTs for the platform. The explanations contained within this document are based on the current design of the system which is constantly evolving and changing as new ideas and functionality are uncovered. As the platform moves forward, functionality may be added to support those new features which supersedes the functionality mentioned in this document. In those cases, the white paper will be updated with new versions to provide information on these changes.

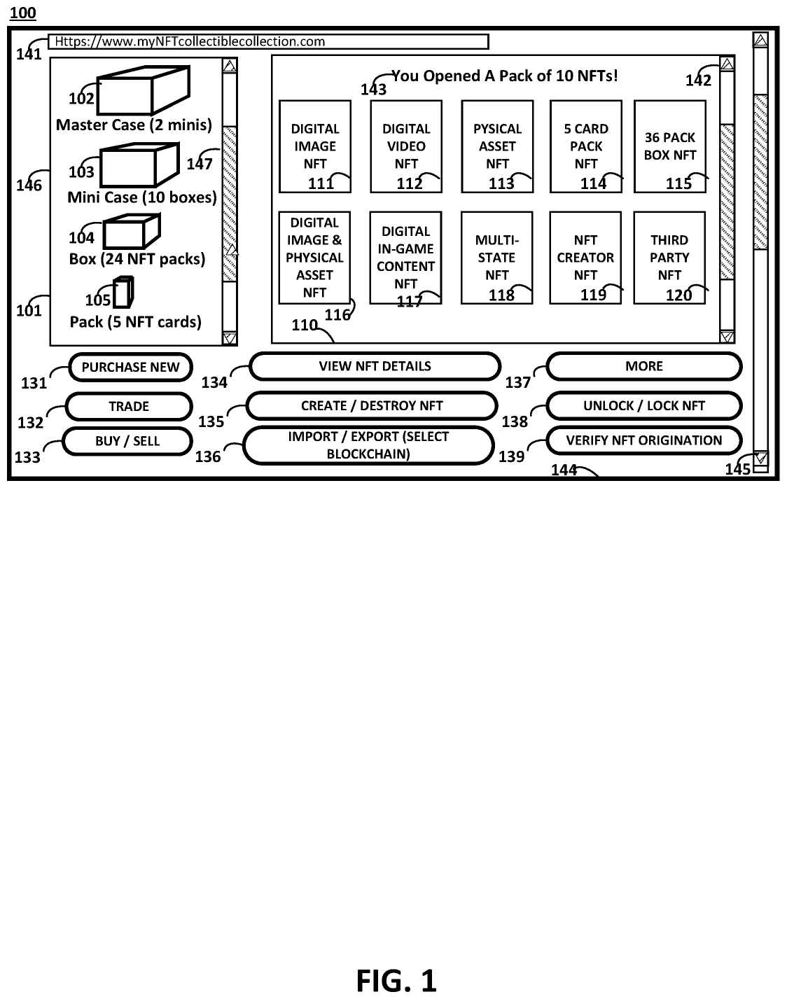

FIG. 1 shows graphical user interface 100 that may include, for example, navigational window 141, interactive window 101 and interactive window 110. Persons skilled in the art will appreciate that graphical user interface 100 may be, for example, any graphical user interface for a platform such as, for example, a webpage browser that is accessing a platform remotely over a communications network (e.g., the intranet) or any type of graphical user interface that is accessing a platform internally (e.g., on the same device as the graphical user interface) or externally (e.g., via a wireless or wire-based access) through one or more devices.

Graphical user interface 100 may be utilized, for example, with a platform for creating, organizing, and transacting digital assets such as digital collectibles. A digital collectible may be, for example, associated with a unique identifier. A public or private blockchain non-fungible token may be utilized, for example, as a structure for a digital collectible. Alternatively, for example, the digital collectible may be a non-fungible token for a non-public or non-private blockchain such as, for example, a platform that creates, organizes, and/or transactions digital assets not using a blockchain (e.g., utilizing one or more secure facilities with one or more secure databases.

A digital collectible may include, for example, media content such as, for example, one or more digital images, videos, audio segments, in-game content, or any other type of media content. The digital collectible may also include a unique identification number as well as one or more associated titles, descriptions, or other text or data. A collectible may be able to be utilized with different platforms in different ways. Accordingly, for example, platform features may have collectible status variables associated with each collectible (e.g., associated with each unique identifier). For example, a collectible may be used (e.g., with other collectibles) to perform a function. The number of times this function may be utilized may be stored in a status variable. For example, if a digital collectible (e.g., a female animal) can be bred with another qualifying collectible (e.g., digital male animal of the same species as the female animal) than the number of times the animal can be used in a breeding process may be stored as feature status data. Any number of feature status data elements may be associated with a unique identifier. A digital collectible may have multiple status identifiers (e.g., a status identifier viewer to administrators of a platform and a publicly viewable status identifier viewable to all users and/or a unique identifier for a private platform such as a public blockchain) and a unique identifier for a public platform such as a public blockchain).

A digital collectible may be, for example, associated with a physical collectible such as one or more sports card, toy, poster, comic book or other memorabilia (e.g., jersey, shoe, shorts, helmet, glove, etc.). Accordingly, a digital collectible may include both a digital asset and a physical asset. An owner of the digital collectible may at any time or in particular circumstances, request the shipping of the physical collectible. Shipping a physical collectible may, for example, destroy the digital collectible or may transition the digital collectible associated with a physical collectible to a digital collectible not associated with a physical collectible. A platform may provide a shipping interface, such as a virtual shipping button, that an owner of a digital collectible associated with a physical collectible can utilize to ship the physical collectible. An interface that displays assets (e.g., media content) from an NFT or other digital collectible may also display additional status identifiers such as whether or not a physical collectible is associated, or still associated, with a digital collectible. The content itself (e.g., a picture of a sportscard) may be altered when status changes such as, for example, a watermark indicating the physical collectible has shipped may be integrated into a picture of the digital collectible as well as additional information (e.g., date shipment was requested and/or date physical collectible shipped). Persons skilled in the art will appreciate that a digital collectible may be associated with more than 1 physical collectible. For example, a digital collectible may be associated with multiple of the same or different physical collectibles and each physical collectible may be shipped individually and/or as a group.

Collectibles, such as digital collectibles, may be exported and imported into the platform. For example, collectibles may be exported and imported into the platform using a private and/or public blockchain. The importing/exporting user may be charged, for example, an import/export fee and this fee may be different between different methods of importing or exporting (e.g., via a public blockchain or via a private blockchain). A user may also remove the collectible, such as a NFT collectible, from the platform directly (e.g., via a download of the NFT) and then may insert the collectible back on the platform (e.g., via an upload). In doing so, the user may secure store the collectible using a preferred storage medium of the user (e.g., a secure storage device of the user). Accordingly, for example, the user may take physical possession of the digital collectible (e.g., digital NFT).

A platform may generate any number of digital collectibles (e.g., over 1 million) and may release the digital collectibles as part of a themed set of collectibles (e.g., a particular sport or brand). The collectibles may be sold directly. The collectibles may also be randomized and placed into sealed packs so that a consumer purchases a pack of randomized collectibles. Digital collectibles of a particular themed set may be produced where each digital collectible has the same quantity as all digital collectibles. Alternatively, for example, digital collectibles may be created for a themed set that have different quantities than the other digital collectibles. Accordingly, different digital collectibles may have different odds associated with them and these odds may be provided to the user on a graphical user interface.

Window 101 shows interactive window 101 that includes one or more pack 105, box 104, mini case 103, and case 102. A pack may have any number of digital collectibles (e.g., NFT collectibles transactable on a public and/or a private blockchain). For example, pack 101 may 1 NFT collectible or more than 1 NFT collectibles (e.g., 5 or more than 5 NFT collectibles).

A particular number of packs may be provided in a box. For example, box 104 may have 24 NFT packs (e.g., 24 of the type of pack of pack 105). A mini case (e.g., half case) may include a particular number of boxes of packs. For example, mini case 104 may include 10 boxes (e.g., 10 boxes of the type of box of box 104). A case may include a particular number of mini cases. For example, master case 102 may include 2 mini cases (e.g., 2 mini cases of the type of mini cases of box 103). Persons skilled in the art will appreciate that a discounted price may be given for structures that include more packs. For example, the per pack price of a master case may be less than the per pack price of a mini case which may be less than the per pack price of a box which may be less than the per pack price of a pack. Person skilled in the art will also appreciate that different types of collectibles may be guaranteed in certain types of sales bundles. For example, a particular type of digital collectible (e.g., a case insert) may be guaranteed in the purchase of a master case but not in the purchase of a mini case.

All of the collectibles of a set of collectibles may be produced and collated into packs and pack-bearing structures before the issuance and/or sale of a single pack. Producing an digital collectible may include, for example, creating a blockchain-based NFT and registering that blockchain-based NFT on a blockchain. For example, a collectible manufacturer may create a million NFT collectibles on a public blockchain using software identifiable only to the collectible manufacturer and then put those NFTs into packs (which may or may not be an NFT itself). As a result, for example, a user may be able to see all of the digital collectibles in packs before the packs are actually opened so a user can see all of the digital collectibles in the set before any of the digital collectibles are offered for sale or sold.

Each collectible, such as each NFT, on a private platform may have a transaction history that is viewable on the platform (e.g., for a user identifiable on the platform such as a user that has a login on the platform) or viewable through a platform where the user does not need to be identified (e.g., a public website). The transaction history may include, for example, when the digital collectible was created, any trades of the digital collectible between users, any sales/purchases of the digital collectible between users, any platform features that were utilized (e.g., a redemption of a platform feature occurred), any additional events as well as associated information (e.g., price of any transaction, tax of any transaction, etc.). Transaction history for a collectible (e.g., a digital NFT collectible associated with a physical collectible) may be viewable based on the collectible, set, or other filtered attributes (e.g., a player name, a year of creation/issuance, a team name, etc.). Data analytics, such as statistical graphs, may also be provided with respect to transactions anchored on one or more filter terms (e.g., transactions anchored around a user such as number of purchases over time, average price paid over time, number of sales over time, average price sold over time, number of packs or digital collectibles purchased from the collectible manufacturer ver time, etc.).

An index for a set of all collectibles of a set may be generated and published (e.g., for private view of users of a private platform such as a privately identified individual on a website or public view on a website accessible by anonymous, unidentified users). Persons skilled in the art will appreciate that the expense to create/register an NFT on a public blockchain may include a cost. Accordingly, an index NFT may be created for a grouping of NFTs such as a particular set of NFTS (e.g., a 2021 issuance of a particular set for a collectible brand). The index NFT may be searchable on the public NFT and the index NFT may include, for example, a website link that provides all of the collectibles of that set and associated information including up-to-date transaction information. Such an index NFT may be created on a public blockchain after the NFTs are created and before the NFTs are sold (e.g., through packs and boxes). Accordingly, an entity may search a public blockchain (e.g., Ethereum classic or Ethereum2), locate the index NFT and be able to reach a website that includes all of the NFTS of a grouping (e.g., a product set) and retrieve information associated with each NFT (e.g., transaction history). Person skilled in the art will appreciate that an index NFT may direct an entity to a website that shows all NFTs but only shows certain information after the NFT is purchased or opened from a pack. Accordingly, for example, a unique identifier for each NFT may be accessible for all NFTs but certain information such as a NFT name, sub-set name, transaction history may not be retrievable until the NFT is purchased or opened from a pack.

Alternatively, each digital collectible for a product set may be created/registered directly on a public blockchain. Each digital collectible may include, for example, a data structure for transactions on the public blockchain and also a data structure for transactions on a private blockchain and/or a website link to a private ledger for transactions with that NFT. Accordingly, NFTs may be created on a public blockchain before being randomized and/or collated under collation rules, and placed into packs, boxes, mini-cases, cases etc. that were already placed on a public blockchain. Alternatively, for example, some or all of the NFTs in a product issuance may, for example, be created on a public blockchain after they are purchased or opened from packs. Accordingly, a digital collectible may be provided in packs and then a public NFT may be created after the packs are opened (e.g., created by a public blockchain wallet identifiable to the user that opened the packs). Persons skilled in the art will appreciate that NFTs may be created by public blockchain software (e.g., a blockchain wallet) associated with a single entity (e.g., “bananaNFT”). The NFT may then be transacted on a ledger (e.g., a private platform) different than the ledger it was created/registered on (e.g., a public blockchain). In doing so, for example, costs and environmental impact may be reduced and transaction speed may be increased. The users of the private platform may have private wallets, public wallets, a combination of private or public wallets, or no wallets. At any time, the digital collectible (e.g., an NFT) may be exported outside of the platform with the ledger different than the public ledger. Accordingly, for example, an NFT may be exported out of the private platform through a public blockchain after it was purchased, opened from a pack, and transacted a number of times between different users (e.g., ownership changed more than 10 times). The exported NFT may include data such as a website link of the private transaction history that occurred outside of the public blockchain or may include the private transaction history itself. As the NFT was created on the public blockchain under the public blockchain software associated with the same entity as the entity exporting (e.g., “BananaNFT”) the blockchain may accept the transaction as the ownership chain is consistent from the perspective of that blockchain. In doing so, for example, a private platform may not require any user to have public blockchain software identifiable to that user for the blockchain associated with the creation of the NFT even though the NFT was created before being placed into packs and even after the NFT was transacted a number of times between different users.

Multiple NFTs for different public blockchains for a single digital collectible may be created and a user may be provided with a choice of different public blockchains to export the digital collectible through. At time of export, the NFT associated with the blockchain desired to be exported may be utilized to add private ledger transaction information for that collectible and transacted. In doing so, for example, a user may select different blockchains based on cost and may retain a creation date before the digital collectible was purchased from the manufacturer or opened from a pack. Accordingly, for example, a user may select a blockchain that has an advantage to that user (e.g., a lower transportation cost or a beneficial feature such as a beneficial security feature). The exported NFTs can then be transacted any number of times on the public blockchain and then imported back into the private platform (e.g., a private blockchain). Once in the private platform, users may continue to transact and the private ledger associated with that collectible may continue to be updated.

Persons skilled in the art will appreciate that an non-NFT digital collectible may be created for a product issuance and randomized and/or collated into product sales structures (e.g., products, boxes, mini-cases, cases). If an exportation is desired, an NFT associated with a desired exportation medium (e.g., a public blockchain) may be created (e.g., an NFT with a smart contract may be created). In doing so, no NFT may need to be created until, for example, an exportation is desired. In doing so, for example, a creation/registration date on a public blockchain may take on an exportation date which may be after the NFT is purchased or opened from a pack.

NFTs may be provided in an NFT such that nested NFTs are provided. For example, a collectible may be an NFT and product sales structures (e.g., packs, boxes, mini-cases, and cases) may also be NFTs. NFT indexes may be provided for each nested layer. Accordingly, for example, a user may buy a case as an NFT and open that NFT to reveal the mini-case NFTs. The user may then keep on mini case and trade the other mini case to a user for a different type of collectible not associated with the issued set of collectibles for the mini-cases. The mini-case that is retained may be stored for a period of time by the user (e.g., more than a year) and then opened to reveal NFT boxes. The user/collector may then sell all of the NFT boxes and keep an NFT box. A period of time later (e.g., over a year), the user may then open up the NFT box to reveal NFT packs and then may open the NFT packs to reveal NFT collectibles. Any NFT may be sold (e.g., for monetary value) or traded (e.g., for other NFT and/or non-NFT collectibles) between users. Transactions (e.g., trades) between more than two parties may be provided (e.g., a three, four, or more than four party trade may be provided). A transaction may be a partial trade/sale where a portion of the received value for one or more collectibles is monetary value and another portion of the received value is non-monetary value.

A user may select an item in interactive window 146 and may, for example, perform actions on the item using a virtual button. An auction may autonomously execute or an additional graphical user interface may be introduced with one or more additional manual input requirements and/or options.

Purchase new option 131 may be, for example, a virtual button on a graphical user interface such as a interface on a mobile phone or computer. Purchase new option 131 may, for example, initiate a purchase process for a selected item such as an item selected in interface window 146. A purchase price may be autonomous based on, for example, a stored platform value (e.g., credit or cryptocurrency associated with a platform) or through an external funding source (e.g., a credit card, debit card, bank account, etc). Persons skilled in the art will appreciate that purchase new option 131 may introduce additional manual input requirements or options such as, for example, selecting of a payment funding source, adding a funding source, or information needed to complete a transaction from a funding source (e.g., the entry of a security code for a payment card such as a CVV or CVC security code). A shopping card may be provided such that, for example, multiple products may be added (e.g., through an add to shopping card option).

Once a sales product is purchased, the product can be stored until a time that a user desires to open, trade, or sell the product. For example, a user may purchase a box of packs of NFTs and may store the box for a period of time (e.g., a year) and then trade the box to a second user and that second user may sell the box to a third user and the third user may open the box and the associated packs. An interactive window may be utilized to view purchased inventory of digital collectibles (e.g., non-NFT digital collectibles, NFT digital collectibles, digital collectibles associated with one or more physical collectibles). Option 131 may be utilized, for example, to initiate a trade with one or more digital collectible and option 133 may be utilized, for example, to initiate a purchase and/or sale of one or more digital collectibles.

NFTs from a sales product that has been opened may be shown in interactive window 110. A users collection of digital collectibles may also be shown in an interactive window (e.g., interactive window 110).

A pack of digital collectibles, or any other grouping or bundle of digital collectibles, may have the same type of digital collectible or a variety of different types of digital collectibles. For example, a pack may include one or more digital image NFTs 111, digital video NFTs 112, physical asset NFTs, grouping or bundle collectibles such as five digital card pack NFT 114, thirty-six pack box NFT 115, digital image and physical asset NFT 116, digital in-game content NFT 117, multi-state NFT 118, NFT Creator NFT 119, third party NFT 120 and/or any other type of digital collectible or other asset.

Digital image NFT may include, for example, one or more digital images. The digital images may be, for example, square, rectangular, or another shape (e.g., non-rectangular shape). The digital images may be of, for example, digital posters, postcards, trading cards, tickets, etc.). For example, a digital image NFT may be a digital trading card with an obverse image and a reverse image. Persons skilled in the art will appreciate that digital image(s) may be provided in the digital collectible or a location where the digital collectibles are located may be included (e.g., a website address for a obverse image of a trading card and another website address for a reverse image of a trading card). Persons skilled in the art will appreciate that an image may be included in an NFT that has multiple resolutions. Accordingly, a website link for a low resolution and a website link for a high resolution of an image. For example, a high resolution image may be stored in an NFT and a low resolution image may be provided via a website link.

Digital video NFT 112 may be provided and may include one or more digital videos. Digital video(s) may be, for example, square videos, rectangular (e.g., widescreen) videos, and may be provided in landscape and/or portrait perspectives. Multiple versions of the same video may be utilized in an NFT such as multiple color schemes, resolutions, frame rates, etc. Accordingly, for example, a high quality video (e.g., high resolution and/or high frame rate video) may be stored in an NFT and a lower quality video may be included in an NFT as a website address to an externally stored version of the video. In doing so, for example, a low quality version of a video may be publicly accessible but a highly quality version may be reserved to the entity that owns the NFT.

Physical asset NFT 113 may be a digital collectible that is associated with a physical asset. For example, a virtual trading card NFT that includes an image of a physical trading card and NFT may provide ownership of that physical trading card. A digital collectible associated with a physical collectible may be, for example, utilized to ship the physical collectible from a remote warehouse. Accordingly, a digital collectible associated with a physical collectible may be purchased in a randomized pack, opened, traded between users any number of times, sold between users any number of times, and then shipped at some point by a user to a shipping address of the users choosing.

Pack NFT 114 may be, for example, any type of bundle of NFT collectibles of the same or different collectible types (e.g., trading cards and posters) which may be randomized or non-randomized. For example, pack NFT 114 may be a complete set of a grouping of collectibles (e.g., trading cards) or a random assortment from a larger set of collectibles. Persons skilled in the art will appreciate that a physical pack or box of cards may be associated with an NFT where the collectibles inside the pack (e.g., individual cards) or the collectibles inside the box (e.g., individual packs) do not have an NFT associated with them. Accordingly, for example, a user that owns such a collectible NFT may ship the pack or box itself to a shipping address of their choosing. Box NFT 115 may include, for example, any number of packs of digital collectibles (e.g., packs of NFT collectibles).

Digital image and physical asset NFT 116 may be included and may include one or more digital images (e.g., website links to the obverse and reverse side scans of a physical trading card). Person skilled in the art will appreciate that additional media may be included in NFT 116 such as one or more videos (with with or without audio) as well as audio-only media segments. Accordingly, for example, a trading card for a particular sports athlete may be provided as an NFT that also includes audio of that sports athlete.

Digital in-game content NFT 117 may be included.

Multi-state NFT 118 may be included and may include an NFT with multiple states such as, for example, an animal that starts off as an egg and then, over time or at some event, upgrades to a young version of the animal and then, over time or at some event, upgrades to an adult version of the animal. Various media content (e.g., images) and platform specific feature variables may be associated with the state the NFT at a particular time. Multi-state NFTs may be one-time use states or multiple time use states. For example, a animal NFT that has grown from an egg to a young animal to an adult animal may be, if a time has passed without an action, for example, downgraded from an adult animal to a young animal to an egg. Persons skilled in the art that a platform generating the NFT may be, for example, the only platform that may change the state of the NFT and, for example, an exportation of the NFT to a different platform may permit the NFT to be purchased/traded/sold on that other platform but specific platform states and features associated with the NFT generating platform may not be accessible. Persons skilled in the art will appreciate that a platform (e.g., a private platform) may provide NFT application interfaces such that third party platforms may be able to provide such features and states (an the execution of a feature or state may involve an autonomous importation into the generating platform, autonomous performance of process, and then autonomous exportation back to the requesting platform)

NFT creator NFT 119 may be included and may be an NFT that may be able to create additional NFTs. Persons skilled in the art will appreciate that an NFT creator NFT may have, for example, a platform function variable with a value equal to the number of times an NFT can be created or data on the NFTs that can be created. A request from an owner of the NFT to generate an NFT may for example change value stored in the NFT for generating NFTs. For example, if a red robin bird NFT in an adult state may lay six red robin bird NFTs in egg state each year and an owner requests an egg be generated, then the available eggs value may be updated from 6 to 5 until a year has passed, in which the value may be updated back to 6. Persons skilled in the art will appreciate that an NFT creator NFT may alternatively, for example, include NFT nesting such that, for example, a red robin bird NFT includes thirty red robin bird NFTs in an egg state. The red robin bird NFT may autonomously increase states after a period of time (e.g., 1 year) and a red robin bird NFT may start as an egg state and then move to a young bird state and then move to an adult bird state. The adult bird state may include the ability to lay six (6) red robin bird NFTs in egg states per year.

Third party NFT 120 may be included. A pack of NFTs may include, for example, NFTs from a single third party, NFTs from multiple third parties, or NFTs from the platform creating the NFT pack as well as NFTs from one or more third parties. NFTs may, for example, purchased in the secondary market and re-packed into packs. Similarly, for example a box may include pack NFTs from multiple different third parties. Accordingly, third party packs may be purchased in the secondary market and utilized to created a re-packed product. Accordingly, for example, a sales product set may be a repack set of digital collectibles purchased on the secondary market (e.g., more than 10,000 digital collectibles or more than 50,000 digital collectibles) and an index may be provided and a private ledger may be kept for the transactions for each of the third party NFTs on the platform that is accessible and viewable by all users of the platform and/or published (e.g., via a website) for anyone having access to the internet.

Person skilled in the art will appreciate that a platform may utilize NFTs with more than one ledger (e.g., two, three, or more than three ledgers). For example, a platform. Dual ledgers (for platform NFTs and third party NFTs) may be utilized for a digital collectible. For example, a digital collectible created by BananaNFT.com on a public blockchain (e.g., Ethereum) ledger may have a second blockchain or non-blockchain ledger on BananaNFT.com. Transactions on BananaNFT.com digital collectible may therefore be recorded in a private ledger and utilized for any reason such as, for example, to update a data field on an NFT at time of export from BananaNFT.com to another platform with the private ledger or, for example, to add data to a data field on a new NFT on a different public blockchain if at the time of export a different public blockchain is desired (and the original NFT on the original public blockchain may be destroyed/inactivated/burned or otherwise rendered inoperable and this inoperability recorded on the public blockchain (e.g., in an additional data field and/or as a ledger function of the public blockchain and/or if the NFT has a link to a webpage for a private ledger an update to that private ledger accessible on the NFT through the webpage link). Accordingly, a ledger on a platform such as a private platform may be used as a primary ledger when a digital collectible is on the platform. Accordingly, for example, a third party NFT may be imported into the private platform and the imported platforms ledger may record transaction activities while on the imported platform on the imported platform ledger. Persons skilled in the art will appreciate that that a platform may update multiple ledgers at the same time. For example, a private platform (e.g., BananaNFT.com) may update a private ledger (e.g., BananaNFT.com ledger) after a transaction for an NFT while also updating a public ledger (e.g., Ethereum). Persons skilled in the art will appreciate that updating the public ledger may be performed in a variety of ways such as for example updating a public ledger using a wallet (e.g., if applicable for that public ledger) for the users involved in a transaction (e.g., if the transaction was a two party transaction involving those users). Alternatively or additionally, for example, if the NFT was created on the public ledger by BananaNFT.com then BananNFT.com could utilize its own wallet for the public ledger to update a BananNFT.com only writable field with an updated transaction history for a transaction for two users. In other words, for example, users of a private platform may not be provided or provided access to wallets for a public ledger (e.g., if the public ledger utilizes a wallet structure) to record transactions and the private ledger itself may record transactions such as recording transactions in data fields accessible only to the private platform wallet for the public ledger. Similarly, when a third-party imported NFT may be imported by the private platform using the identity of the private platform as the importer. Once on the private platform, the private platform may utilize a private ledger for updated transactions. At exportation, the third-party NFT (e.g., an NFT created by a third party) may be exported by the private platform. Persons skilled in the art will appreciate that a public ledger may not be updated with all transactions on a private ledger. Accordingly, for example, transaction activities on a private ledger (e.g., BananaNFT.com) may be kept private from a public blockchain (e.g., Ethereum) while still preserving the NFT so it can be imported and exported between the private platform and Ethereum, for example, any number of times. Alternatively, for example, the third party NFT may be updated with data if, for example, the private platform (e.g., BananaNFT) has a data field the private platform is able to update. Persons skilled in the art will appreciate that a public blockchain may, for example, keep an entire record of an NFT with all data fields on all processors of the public blockchain (e.g., miners) in certain parts of its code or data so any part of any NFT on the public blockchain can be located at any time (e.g., so long as the NFT has been updated on the public blockchain).

Option 134 may be utilized, for example, to view the NFT details of a particular NFT. Such NFT details may include any information on the NFT as well as additional information (e.g., information about NFTs of the same player, set, product year, etc.).

Option 135 may be utilized, for example, to initiate an NFT creation process for a user or delete an NFT. A process for creating an NFT may include, for example, obtaining content (e.g., media content such as a video) as well as a title. Deleting a NFT may include, for example, deleting an NFT from a platform (e.g., a private platform) or disabling it so it can no longer be transacted to another entity.

Option 136 may include an option to import and/or export a collectible, such as a digital collectible, from one or more blockchains. Persons skilled in the art will appreciate that an importation and/or exportation may occur one at a time or in bulk (e.g., more than one such as more than ten).

Option 137 may be included on any interactive screen such as a screen displayed on a computer (e.g., a laptop) or a mobile telephonic device. Option 137 may be included to, for example, open a new interactive graphical interface or expand a interactive graphical interface to include additional options. In doing so, option 137 may be utilized to reduce the size of a graphical user interface and/or include the ability to include additional options not, for example, able to fit on a graphical user interface. Persons skilled in the art will appreciate that option 137 may be dynamic and may change based on a type of device that is sensed by a platform. For example, a mobile telephonic phone may be sensed (e.g., via an internet connection) and may be provided with a graphical user interface that includes option 137 and when a home computer is sensed (e.g., via an internet connection) a graphical user interface may be provided without option 137.

Option 138 may be utilized, for example, to initiate a lock or unlocking capability. A digital collectible, for example, may be locked to prohibit a feature such as, for example, the collectible being viewable on a platform, being tradeable on the platform, being sellable on a platform, being exportable on a platform, and/or any combination of these as well as additional capabilities. Any feature associated with any option may be utilized to perform the feature on one collectible or more than one collectible. For example, a user may select any number of collectibles and use option 138 to apply a lock or unlocking feature to all selected collectibles. Persons skilled in the art will appreciate that option 138 may be two options such as a lock option and an unlock option. If a group of collectibles are selected and a lock option is utilized and a few of that group of collectibles are already locked, then only, for example, the unlocked collectibles may be locked. Person skilled in the art will appreciate that additional security may be associated with a lock and/or unlock feature such as an additional password or a randomized one-time use password (e.g., a dual-factor authentication process). Accordingly, for example, a consumer may lock a subset of collectibles utilizing a dual factor authentication (e.g., a one-time use password being emailed to the user's personal email or sent via a text message to the user's personal cell phone) so that the subset of collectibles, for example, require the same dual-factor authentication (or a different security layer) to unlock so a capability (e.g., trade, sale, and/or export) may be performed. In doing so, a consumer can select certain collectible to have heightened security and certain collectibles to have a faster, for example, transaction capability (e.g., trade, sale, and/or exportation)

Persons skilled in the art will appreciate that digital collectibles may have particular platform features or other features. For example, an NFT may be utilized to perform an action in a video game. An NFT feature may be utilized, for example, via option 139. Any number of options may be included to use a feature of an NFT. For example, if an NFT has 10 platform and/or NFT features, that NFT may have 10 separate interfaces for receiving manual input to utilize such features. Persons skilled in the art will appreciate that certain features may not be available until eligibility requirements are met. Such eligibility features may be, for example, time-based and/or event-based. An option that is not available for utilization as a result of eligibility requirements not yet being met may be viewable. For example, an option that is usable dependent on eligibility requirements may have a certain appearance (e.g., color) when the eligibility requirements are not yet met and the status of the eligibility requirements may be displayed to the consumer so the consumer can, for example, understand what needs to be accomplished to meet those eligibility requirements.

Option 139 may be provided, for example, to validate that an NFT on one ledger is associated with a peer NFT on another ledger ledgers such as, for example, using, for example, the smart contract of a public blockchain (e.g., Ethereum) that may include an intermediate identifier that links the NFTs on the two ledgers together. Accordingly, a collectible NFT may be provided as a relational database NFT in one system and a smart contract may be provided on a public blockchain that lists the relational NFT as being a valid relational NFT that is, or will be, associated with an NFT on the public blockchain. Thus, for example, a public blockchain NFT may not be minted until a relational database NFT is exported from a relational database ledger, an association is preserved via a smart contract on the public blockchain before, and after, the NFT is ultimately minted through an identifier (e.g., token) provided on the smart contract on the public (e.g., or private) blockchain).

One example of a smart contract for verification may be, for example:

Persons skilled in the art will appreciate that multiple smart contracts may be provided on a single blockchain (e.g., public blockchain) in order to, for example, reduce the costs of performing various steps of an object (e.g., collectible) associated with token, such as a non-fungible token, on the public blockchain. For example, creating a token for an individual collectible may have a cost that is greater than creating a token for a product of multiple collectibles and associating multiple collectibles to that product. In doing so, for example, a product that is associated with a numerical range of collectibles identifiers may be placed on a blockchain at a first date so that date is associated with the product. At a later date, such as when an individual collectible is desired to be placed as its own token on a blockchain (e.g., a collectible is desired to be exported from a private ledger to a public blockchain) the token can be created and the expense may be incurred (e.g., incurred and passed onto the owner of the collectible). The date of creation of the individual collectible token, however, may have a date that is after (e.g., by years or decades or centuries) after the collectible was actually created (e.g., on the private ledger). Accordingly, the collectible item may be associated before an initial sale to an initial owner to a product of multiple collectibles on a public blockchain so that a date may be associated to the collectible before private sale and the collectible may be associated with an individual token itself when, for example, exported to the public blockchain. Albeit, for example, the creation of the individual collectible token on the blockchain may occur after the primary sale, the association of the collectible to the original product may have occurred before the primary sale and this original pre-sale association may be verified. In doing so, the cost of exporting a collectible from a private ledger to a public blockchain may be delayed until the time of export without, for example, sacrificing the ability to trace the origin of the collectible to a date associated before the primary sale (e.g., by verifying the association to the product token and the collectibles association with that private token).

More particularly, a collectible may be provided with a unique identification on a private ledger (e.g., “12345”). An intermediary smart contract may, for example, provide a unique token on a blockchain and may, for example, provide a range of intermediary numbers (e.g., “1 to 5,000,000”) for that product identifier (e.g., “product 56789”) and the unique private identifier may be associated with one of the intermediary numbers (e.g., product “50”) of the product identifier. Such identifiers/tokens may be created before the sale of the product of collectibles so that the date of the product token and associations exists before sale. A second smart contract may be utilized to create a full token for a collectible of the private ledger when, for example, that token is desired to be exported to the public blockchain. In doing so, the cost to create the token on the blockchain for the collectible may be delayed until a time after the initial sale (e.g., the time of export). The public token (e.g., “98765”) may be associated for a collectible to its intermediate identifier (e.g., “56789”) for the product (e.g., product “50”). The smart contracts may include verification functions to verify the associations. The private ledger may have a webpage that includes each private ledger token and its association to, for example, a product and intermediate range identifiers and the token and/or intermediate identifiers may be selectable and, when selected, full information for the private token may be provided (e.g., full history, collectible image(s), collectible information, any selling price, etc.). The private leder webpage may also provide any public blockchain token numbers and the associated blockchain as well so that a user can see on a single page the private token, public token, intermediate product, and intermediary identifier for a single collectible. With such a structure, for example, a public blockchain collectible may then be imported back into a private system and a exported to a different blockchain using a different intermediary product and intermediary range identifier. Accordingly, before a collectible is sold, a number of intermediary smart contracts may be provided across several blockchains so that a collectible may be exported to any one of those blockchains after a sale and have origin information associated to a date on the blockchain before the sale using the intermediary blockchain for that collectible. If re-imported, for example, the token may be imported into a wallet associated with the private ledger and a webpage associated with the collectible or the ledger may show all the blockchains where the collectible has resided and the blockchain where the collectible currently resides (and can reside in the future). New smart contracts (e.g., an intermediary product creation smart contract and a individual collectible creation smart contract) may be deployed to new blockchains so a token may be exported to those new blockchains. A product intermediary smart contract may have products added at any times with different collectible range and range identifiers created for each product.

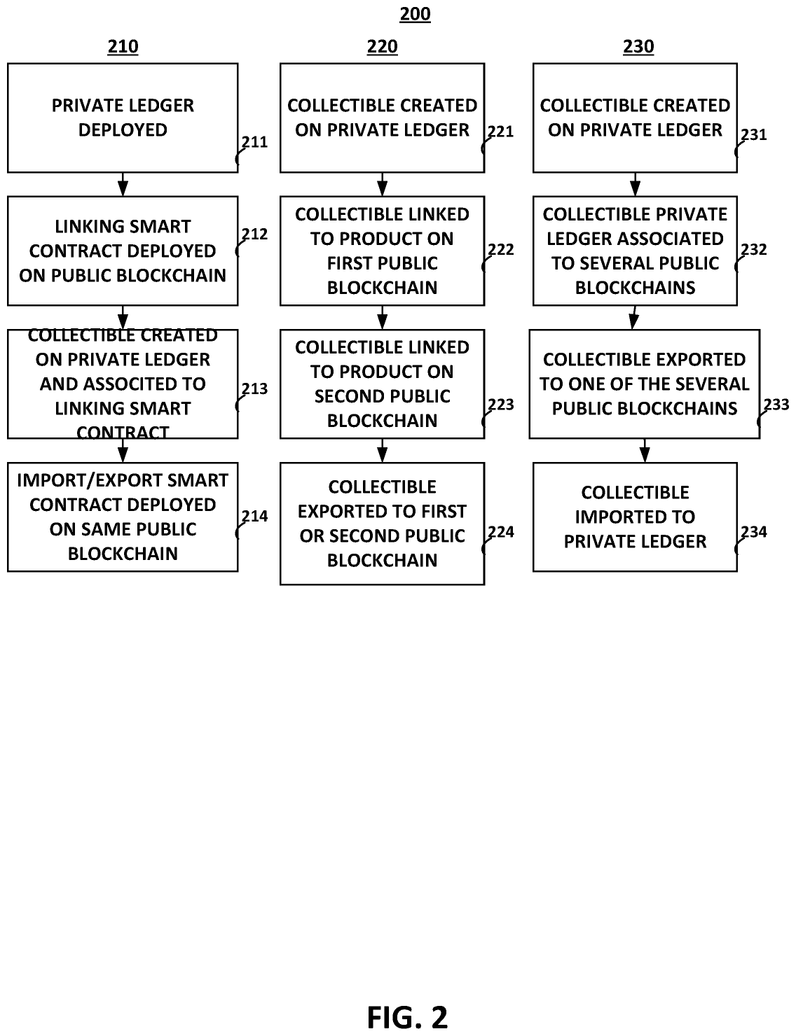

FIG. 2 includes flow chart 210 that may include step 211 in which a private ledger is deployed. Collectibles may be purchased (e.g., in blink packs of multiple collectibles), traded, sold, and exported from the private ledger. A linking smart contract may be deployed on a public blockchain in step 212. A collectible may be created on a private ledger in step 213 and associated to the linking smart contract on the public blockchain. An import/export smart contract may be deployed on the same public blockchain so the collectible may be created as a token on the public blockchain in step 214. An intermediary identifier for the collectible may be provided in the linking smart contract at a first cost and an additional identifier for the collectible may be provided in the export/import smart contract at a second cost. The second cost may be greater, for example, than the first cost. The second smart contract may include additional information for a collectible such as, for example, a link to a picture or pictures (e.g., using the interplanetary file system), provenance information, collectible name information, and other information. The additional information may provide, for example, additional cost and more information provided for a collectible on the import/export smart contract may provide for a differential more cost when compared to the linking smart contract. Persons skilled in the art will appreciate that a two smart contract system (or a system with more than two smart contracts) may permit a collectible to have a light presence on a blockchain before an event (e.g., full export to the blockchain) and a heavier presence on a blockchain after an event (e.g., full export to the blockchain) so that the collectible can be associated with the lighter presence at a lower cost before the event and associated with the heavier presence after the event when the cost of the heavier presence is desired.

FIG. 2 includes flow chart 220 in which a collectible is created on a private ledger in step 221 and the collectible is linked (e.g., associated) to a product on a first public blockchain in step 222 (e.g., via a first smart contract). The collectible may be linked to a product on a second blockchain in step 223. Any number of linking smart contracts and linkings may be provided to any number of systems (e.g., private and/or public ledgers such as private and/or public blockchains). The collectible may be exported to a blockchain with, for example, a linking smart contract using a different smart contract in step 224. Persons skilled in the art will appreciate that a single smart contract may be provided instead of two smart contracts. Creating two smart contracts, however, may decrease the cost of provisioning the linking smart contract as the exportation/importation smart contract may be provisioned after the same of the collectible (e.g., the same of the product that includes the collectibles).

FIG. 2 includes flow chart 230 that may include step 231 in which a collectible is created on a private ledger (e.g., prior to an initial sale to an initial consumer). The collectible private ledger may be associated to several blockchains in step 232 (e.g., a collectible may be associated to a smart contract of a blockchain). The collectible may be exported to one of the several blockchains in step 233 and the collectible may be imported to the private ledger in step 234 (and then exported to the same or a different public or different private ledger).

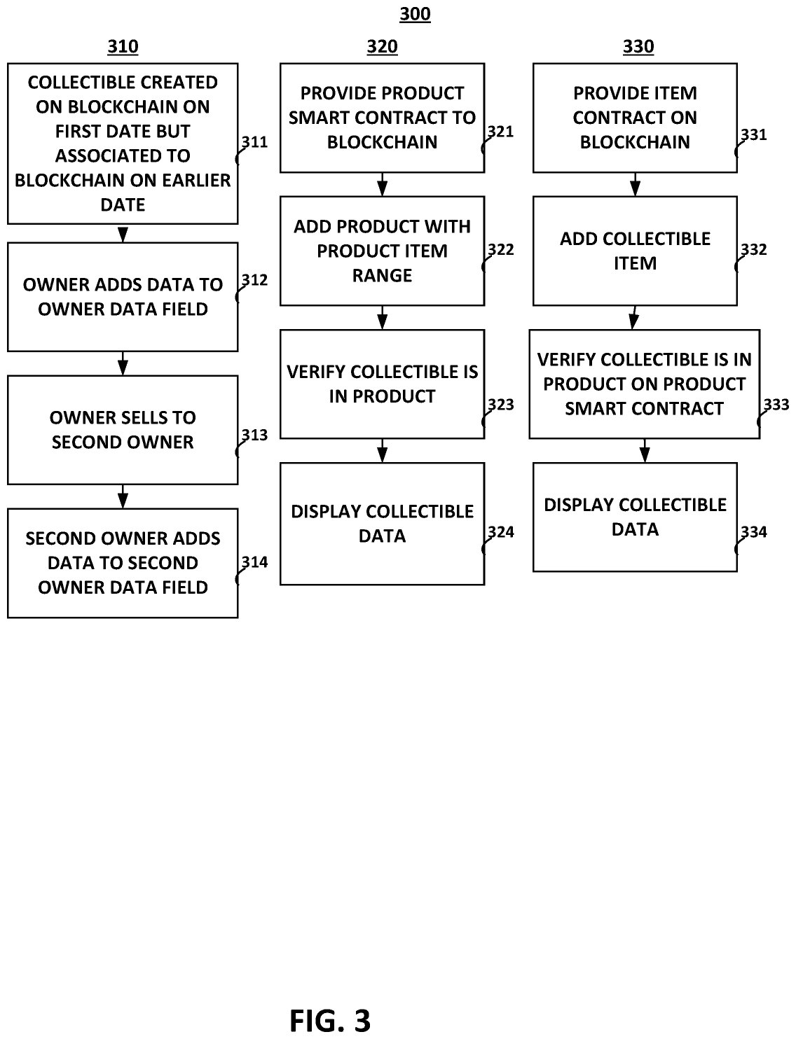

FIG. 3 includes flow chart 310, in which a collectible may be created on a blockchain on a first date but associated to the blockchain on an earlier date (e.g., via a product linking smart contract and/or an intermediary identifier with lighter data) in step 311. Step 312 may be included in which an owner may add owner specified data to an owner data field. The collectible may then be transacted (e.g., traded or sold) to a different owner in step 313 and the new owner may add data to a second owner data field in step 314. Persons skilled in the art will appreciate that a non-fungible token may be provided with a data structure where owners can add data to the non-fungible token in a data field reserved for each owner. When a new ownership occurs, if the new ownership has not owned the token before, the smart contract may be utilized to create a data field for the new owner so that data may be written, modified, and/or erased by that owner. Accordingly, a non-fungible token may be transacted through different services and/or users and each service and/or user may add data to the token. User created data may be viewable by all users. Accordingly, for example, a token may be provided to a service, such as a gaming service, and the token may be used in a game and game data may be stored in the token which may increase the value of the token and the token may be sold and moved to a different service (e.g., an insurance service) where data for that service (e.g., insurance policy data) may be added to the token. In this manner, value may be added to tokens and system interoperability data may be added as tokens enter systems and that data may be kept with the token as it moves through owners and services.

FIG. 3 includes flow chart 320 in which step 321 may be provided in which a product mart contract may be provisioned to a blockchain in step 321. Step 322 may be included in which a product may be added with a product identifier range. A collectible may be verified as being in a product in step 323 (e.g., a collectible from a private ledger may be verified as having an association with a product on a product smart contract). Collectible data associated with any ledger associated with a collectible (e.g., through a product smart contract or other system) may be provided in step 324.

FIG. 3 includes flow chart 330 in which an item smart contract may be provided on a blockchain in step 331 and a collectible item may be added in step 332. The collectible may be verified as being in a product in a product smart contract in step 333 and collectible information may be displayed in step 334. Data may be displayed from the private ledger and/or public smart contract(s).

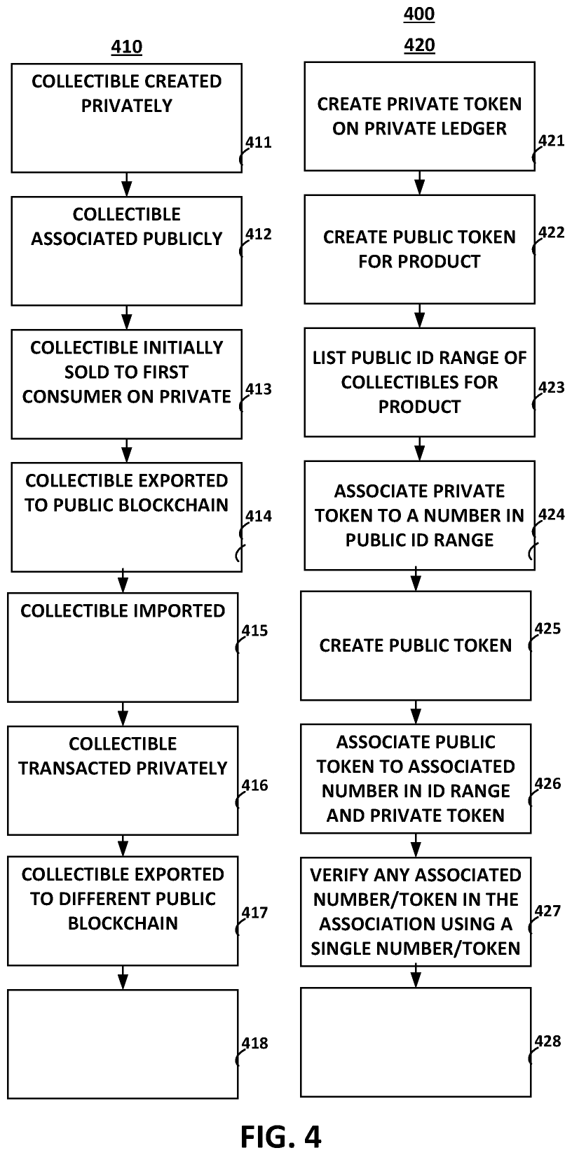

FIG. 4 includes flow chart 410 in which a collectible is created privately (e.g., on a private ledger of a private system) in step 421. The collectible may be associated publicly on a public system such as a public blockchain in step 412 and the collectible may be initially sold to a first consumer on the private ledger in step 413 and the collectible may be exported to the public blockchain on step 414 and the collectible may be imported back, for example, to the private system in step 416 and the collectible may be exported to a different public blockchain in step 417 and additional steps may occur such as step 418. Step 418 may include a number of steps including, for example, re-importation to the private ledger (e.g., where users of the private system may be able to view the collectible if the collectible, for example, is made viewable to the users of the private system).

FIG. 4 includes flow chart 420 that includes a private token created on a private ledger in step 421 and a public token for a product created in step 421 and a public ID range of collectibles for the product of collectibles are listed in step 423 and the private token is associated to a number in the public ID range in step 424 and a public token is created for the collectible in step 425 and the public token is associated to the associated ID number and private token in step 426 and the private token, public token, ID in product ID range is verified as being associated in step 427. Any additional steps may be included as, for example, step 428 including selling the collectible to another user (e.g., a user of the system where the collectible resides such as a public blockchain when exported and a private system before exportation or after importation back to the private system).

Persons skilled in the art will appreciate that elements of any device herein may be utilized in any device herein. Persons skilled in the art will also appreciate that the present invention is not limited to only the embodiments described. Instead, the present invention more generally involves uniquely identified data and secure methods for storing and operating on the same. Persons skilled in the art will also appreciate that the apparatus of the present invention may be implemented in other ways then those described herein. All such modifications are within the scope of the present invention, which is limited only by the claims that follow.

What is claimed is:

1. A system comprising:
a relational database non-fungible token associated with a collectible;
a identifier provided on a smart contract located on a public blockchain associated with said collectible; and
a public blockchain token located on said public blockchain associated with said collectible, wherein said public blockchain token was created after said relational database token was created.

2. The system of claim 1, wherein a verification smart contract is provided on said public blockchain for verifying said relational database non-fungible token association with said collectible to said identifier and for verifying said public blockchain token associated with said collectible to said identifier.
